(19) United States
(12) Patent Application Publication
(10) Pub. No.: US 2025/0249694 A1
(43) Pub. Date: Aug. 7, 2025

(54) IMAGE FORMING APPARATUS CAPABLE OF FORMING IMAGE ON WHICH TILT OF IMAGE PICKUP PORTION IS REFLECTED, AND IMAGE FORMING METHOD

(71) Applicant: KYOCERA Document Solutions Inc., Osaka (JP)

(72) Inventor: Yuichiro Kurokawa, Osaka (JP)

(21) Appl. No.: 19/041,393

(22) Filed: Jan. 30, 2025

(30) Foreign Application Priority Data
Feb. 2, 2024 (JP) 2024-014904

(51) Int. Cl. B41J 11/00; B41J 2/155; B41J 11/62

(52) U.S. Cl. CPC B41J 11/008; B41J 2/155; B41J 11/007; B41J 11/0095; B41J 11/62; B41J 2202/21

(57) ABSTRACT

An image forming apparatus acquires shape data indicating a shape of a specific sheet conveyed along a conveying path, masks, using the acquired shape data, a stick-out area that sticks out from a sheet area included in the shape data out of specific image data whose size in a first direction corresponding to a conveying direction of a sheet is larger than that of the sheet area, and forms, on the specific sheet, an image that shows a boundary between a mask area and a non-mask area opposing each other along the first direction out of the specific image data in which the stick-out area has been masked.

### INCORPORATION BY REFERENCE

This application is based upon and claims the benefit of priority from the corresponding Japanese Patent Application No. 2024-014904 filed on Feb. 2, 2024, the entire contents of which are incorporated herein by reference.

### BACKGROUND

The present disclosure relates to an image forming apparatus and an image forming method.

There is known an image forming apparatus including an image pickup portion such as a line sensor which images a sheet conveyed via an image forming position of an image forming portion. There is also known, as the related art, an image forming apparatus capable of detecting, based on an image pickup result of the image pickup portion on a mark image that is formed on a conveying belt used for conveying the sheet and is elongated in a width direction orthogonal to a conveying direction of the sheet, a tilt of the image pickup portion with respect to the width direction.

### SUMMARY

An image forming apparatus according to an aspect of the present disclosure includes an image forming portion, an image pickup portion, a conveyance processing portion, an acquisition processing portion, a mask processing portion, and a forming processing portion. The image forming portion forms an image on a sheet conveyed along a predetermined conveying path. The image pickup portion is provided while being elongated along a width direction orthogonal to a conveying direction of the sheet at a position more on an upstream side of the conveying direction than the image forming portion on the conveying path, and images the sheet. The conveyance processing portion conveys a predetermined specific sheet along the conveying path. The acquisition processing portion acquires shape data indicating a shape of the specific sheet conveyed by the conveyance processing portion using the image pickup portion. The mask processing portion masks, using the shape data acquired by the acquisition processing portion, a stick-out area that sticks out from a sheet area included in the shape data out of specific image data whose size in a first direction corresponding to the conveying direction is larger than that of the sheet area. The forming processing portion forms, on the specific sheet, an image that shows a boundary between a mask area and a non-mask area opposing each other along the first direction out of the specific image data in which the stick-out area has been masked by the mask processing portion.

An image forming method according to another aspect of the present disclosure is executed in an image forming apparatus including an image forming portion which forms an image on a sheet conveyed along a predetermined conveying path, and an image pickup portion which is provided while being elongated along a width direction orthogonal to a conveying direction of the sheet at a position more on an upstream side of the conveying direction than the image forming portion on the conveying path, and images the sheet, and includes a conveyance step, an acquisition step, a mask step, and a forming step. The conveyance step includes conveying a predetermined specific sheet along the conveying path. The acquisition step includes acquiring shape data indicating a shape of the specific sheet conveyed in the conveyance step using the image pickup portion. The mask step includes masking, using the shape data acquired in the acquisition step, a stick-out area that sticks out from a sheet area included in the shape data out of specific image data whose size in a first direction corresponding to the conveying direction is larger than that of the sheet area. The forming step includes forming, on the specific sheet, an image that shows a boundary between a mask area and a non-mask area opposing each other along the first direction out of the specific image data in which the stick-out area has been masked in the mask step.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a cross-sectional view showing a configuration of an image forming apparatus according to an embodiment of the present disclosure;

FIG. 2 is a plan view showing configurations of an image forming portion, a conveying unit, and a line sensor in the image forming apparatus according to the embodiment of the present disclosure;

FIG. 3 is a block diagram showing a system configuration of the image forming apparatus according to the embodiment of the present disclosure;

FIG. 4 is a flowchart showing an example of tilt-reflected image forming processing executed in the image forming apparatus according to the embodiment of the present disclosure;

FIG. 5 is a diagram showing an example of shape data acquired in the image forming apparatus according to the embodiment of the present disclosure;

FIG. 6 is a diagram showing an example of the shape data acquired in the image forming apparatus according to the embodiment of the present disclosure;

FIG. 7 is a diagram showing an example of specific image data that is masked in the image forming apparatus according to the embodiment of the present disclosure;

FIG. 8 is a diagram showing an example of the specific image data that has been masked in the image forming apparatus according to the embodiment of the present disclosure;

FIG. 9 is a diagram showing an example of an image formed on a specific sheet in the image forming apparatus according to the embodiment of the present disclosure;

FIG. 10 is a diagram showing an example of an image formed on the specific sheet in the image forming apparatus according to the embodiment of the present disclosure; and

FIG. 11 is a block diagram showing a system configuration of an image forming apparatus according to another embodiment of the present disclosure.

### DETAILED DESCRIPTION

Hereinafter, embodiments of the present disclosure will be described with reference to the attached drawings. It is noted that the following embodiments are each an example of embodying the present disclosure and do not limit the technical scope of the present disclosure.

### [Configuration of Image Forming Apparatus 100]

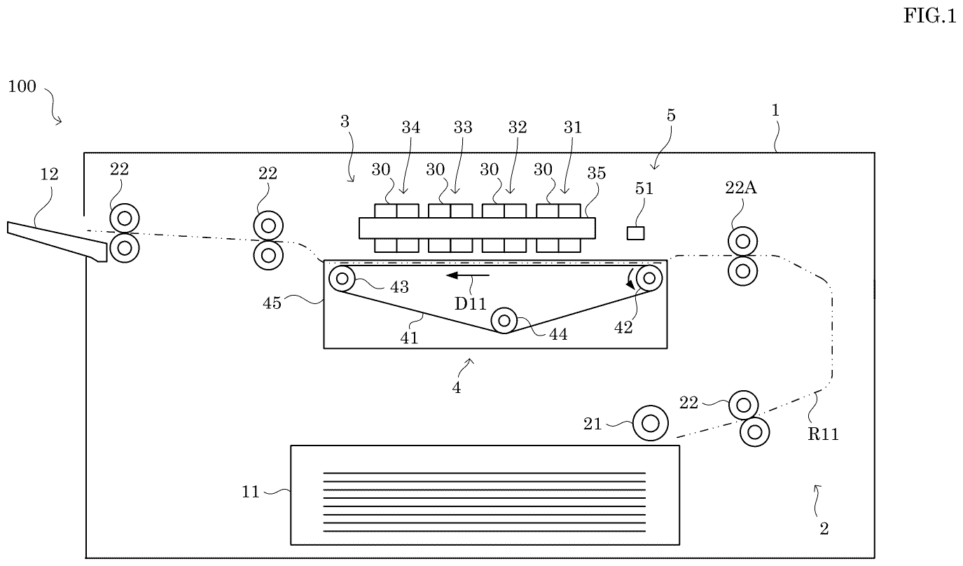

First, a configuration of an image forming apparatus 100 according to an embodiment of the present disclosure will be described with reference to FIG. 1 to FIG. 3. It is noted that in FIG. 1, a sheet conveying path R11 is indicated by a dash-dot-dot line.

The image forming apparatus 100 is a printer that is capable of forming an image on a sheet using an inkjet system. It is noted that the present disclosure may also be applied to a facsimile apparatus, a copying machine, or a multifunction peripheral that is capable of forming an image on a sheet using the inkjet system. Alternatively, the present disclosure may be applied to an image forming apparatus capable of forming an image on a sheet using a system different from the inkjet system, such as electrophotography.

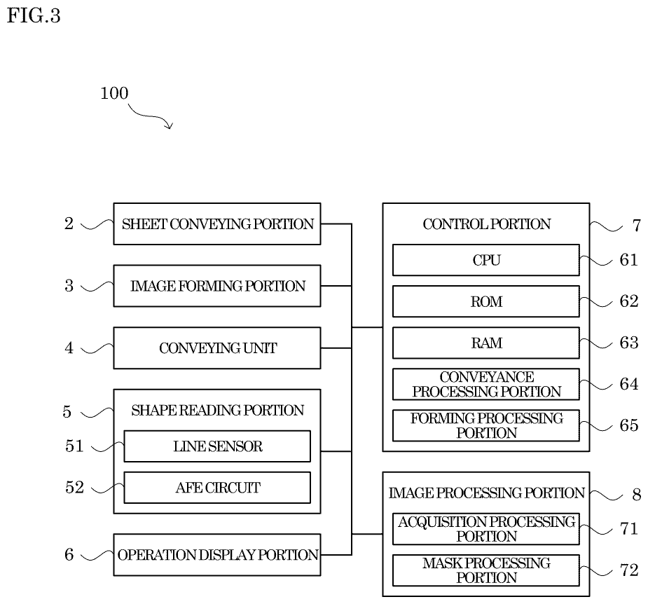

As shown in FIG. 1, the image forming apparatus 100 includes a housing 1, a sheet conveying portion 2, an image forming portion 3, a conveying unit 4, a shape reading portion 5. Further, the image forming apparatus 100 includes an operation display portion 6, a control portion 7, and an image processing portion 8 shown in FIG. 3.

The housing 1 accommodates respective constituent elements of the image forming apparatus 100. A sheet feed cassette 11 (see FIG. 1) is detachably provided in the housing 1. The sheet feed cassette 11 stores sheets on each of which an image is to be formed. A sheet discharge tray 12 (see FIG. 1) is provided on an outer side surface of the housing 1. A sheet on which an image has been formed by the image forming portion 3 is discharged onto the sheet discharge tray 12. Inside the housing 1, the sheet stored in the sheet feed cassette 11 is conveyed along the sheet conveying path R11 (see FIG. 1) that reaches the sheet discharge tray 12 via an image forming position of the image forming portion 3.

The sheet conveying portion 2 conveys the sheet stored in the sheet feed cassette 11 along the sheet conveying path R11 (see FIG. 1). As shown in FIG. 1, the sheet conveying portion 2 includes a pickup roller 21 and a plurality of conveying rollers 22. The pickup roller 21 takes out an uppermost sheet out of a batch of sheets stored in the sheet feed cassette 11, and feeds the sheet to the sheet conveying path R11. The plurality of conveying rollers 22 are provided so as to be aligned along the sheet conveying path R11. Each of the conveying rollers 22 conveys the sheet along the sheet conveying path R11. Each of the conveying rollers 22 conveys the sheet in a conveying direction D11 (see FIG. 1) that is directed from the sheet feed cassette 11 toward the sheet discharge tray 12.

The image forming portion 3 forms an image on the sheet conveyed along the sheet conveying path R11 (see FIG. 1) (an example of a conveying path according to the present disclosure). As shown in FIG. 1, the image forming portion 3 includes line heads 31 to 34 and a head frame 35.

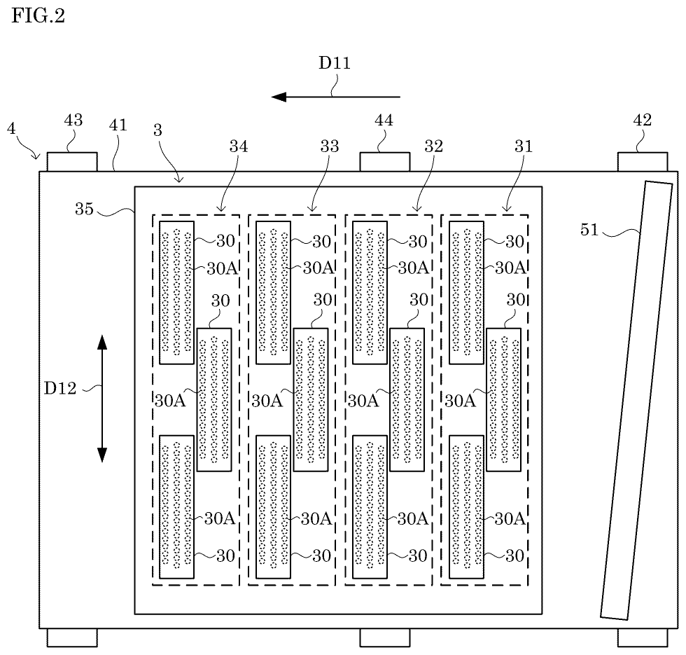

As shown in FIG. 2, each of the line heads 31 to 34 is elongated in a width direction D12 orthogonal to the conveying direction D11. Specifically, each of the line heads 31 to 34 has, in the width direction D12, a length corresponding to a width of a sheet of a maximum size out of the sheets that can be stored in the sheet feed cassette 11. The line heads 31 to 34 are provided so as to be aligned at regular intervals along the conveying direction D11.

As shown in FIG. 2, each of the line heads 31 to 34 includes a plurality of recording heads 30. Each of the recording heads 30 discharges ink toward the sheet conveyed by the conveying unit 4. Each of the recording heads 30 provided in the line head 31 discharges black ink. Each of the recording heads 30 provided in the line head 32 discharges cyan ink. Each of the recording heads 30 provided in the line head 33 discharges magenta ink. Each of the recording heads 30 provided in the line head 34 discharges yellow ink.

Each of the recording heads 30 includes a plurality of nozzles 30A (see FIG. 2) that discharge ink. The plurality of nozzles 30A are provided on an opposing surface of the recording head 30 that opposes the sheet conveyed by the conveying unit 4.

Further, each of the recording heads 30 includes pressurization chambers (not shown), piezoelectric elements (not shown), and individual flow paths (not shown) that respectively correspond to the nozzles 30A. The pressurization chamber is in communication with the nozzle 30A and stores ink. The piezoelectric element causes the ink to be discharged from the nozzle 30A in accordance with an application of a predetermined driving voltage. The individual flow path is an ink flow path provided between the pressurization chamber and a common flow path (not shown) common to the plurality of nozzles 30A. The plurality of individual flow paths respectively corresponding to the plurality of nozzles 30A are connected to the common flow path. The common flow path is connected to an ink supplying portion (not shown) that supplies the ink to each of the pressurization chambers.

As shown in FIG. 2, the line head 31 includes three recording heads 30 that are arranged in a staggered pattern along the width direction D12. Similar to the line head 31, each of the other line heads 32 to 34 also includes three recording heads 30 that are arranged in a staggered pattern along the width direction D12.

The head frame 35 supports the line heads 31 to 34. The head frame 35 is supported by the housing 1. It is noted that the number of line heads to be provided in the image forming portion 3 does not need to be four. Further, the number of recording heads 30 to be provided in each of the line heads 31 to 34 does not need to be three.

The image forming portion 3 forms an image that is based on image data input from the image processing portion 8 on the sheet. Specifically, the image forming portion 3 controls discharge of ink by each of the line heads 31 to 34 based on the image data input from the image processing portion 8.

As shown in FIG. 1, the conveying unit 4 is arranged below the line heads 31 to 34. The conveying unit 4 conveys the sheet while causing the sheet to oppose the recording heads 30. For example, the conveying unit 4 conveys the sheet by a predetermined conveying amount every time the discharge of the ink is performed by the recording head 30. Further, while the discharge of the ink is performed by the recording head 30, the conveying unit 4 stops the conveyance of the sheet. As shown in FIG. 1, the conveying unit 4 includes a conveying belt 41 on which the sheet is to be placed, a first tension roller 42, a second tension roller 43, and a third tension roller 44 across which the conveying belt 41 is stretched, and a conveying frame 45 that supports these. It is noted that a gap between the conveying belt 41 and the recording heads 30 is adjusted such that a gap between a surface of the sheet and the recording heads 30 during image formation becomes a predetermined distance (for example, 1 mm).

The first tension roller 42 is rotationally driven by a rotational driving force supplied from a motor (not shown). Thus, the conveying belt 41 rotates in a direction in which the sheet can be conveyed in the conveying direction D11 (see FIG. 1). It is noted that the conveying unit 4 is also provided with a suction unit (not shown) or the like that sucks in air via a large number of through-holes formed in the conveying belt 41 to cause the sheet to stick to the conveying belt 41.

The shape reading portion 5 reads a shape of the sheet conveyed along the sheet conveying path R11.

As shown in FIG. 3, the shape reading portion 5 includes a line sensor 51 and an AFE (Analog Front End) circuit 52.

As shown in FIG. 1, the line sensor 51 is provided more on an upstream side of the conveying direction D11 of the sheet than the image forming portion 3 on the sheet conveying path R11. Further, the line sensor 51 is provided above the conveying belt 41. Furthermore, as shown in FIG. 2, the line sensor 51 is provided while being elongated along the width direction D12 orthogonal to the conveying direction D11. The line sensor 51 images the sheet conveyed along the sheet conveying path R11. The line sensor 51 is an example of an image pickup portion according to the present disclosure.

For example, the line sensor 51 is a CIS (Contact Image Sensor). The line sensor 51 includes a plurality of image pickup devices that are arranged so as to be aligned in the width direction D12 (see FIG. 2). Each of the image pickup devices includes a light-emitting portion and a light-receiving portion. The light-emitting portion emits light toward the conveying belt 41. The light-receiving portion is provided to be capable of receiving the light that is emitted from the light-emitting portion and reflected by the conveying belt 41 or the conveyed sheet, and outputs analog electric signals corresponding to the received light amount. The line sensor 51 images the sheet conveyed along the sheet conveying path R11 at a predetermined image pickup cycle. Specifically, the line sensor 51 outputs analog electric signals corresponding to an image of an image pickup target (the sheet or the conveying belt 41) opposing the line sensor 51 at the image pickup cycle. It is noted that an outer circumferential surface of the conveying belt 41 is colored in a color with which reflection of light emitted from the light-emitting portion is suppressed more than a base color of a sheet (white), as exemplified by black.

The AFE circuit 52 is an electronic circuit which executes predetermined processing on the analog electric signals output from the line sensor 51. Specifically, the AFE circuit 52 includes a signal conversion portion which converts the analog electric signals output from the line sensor 51 into digital electric signals (image data). Further, the AFE circuit 52 includes a binarization portion which executes binarization processing on the image data output from the signal conversion portion. The binarization processing is processing of binarizing each pixel included in the image data output from the signal conversion portion to a value indicating presence or absence of a sheet. The image data binarized by the binarization portion (hereinafter, will be referred to as “line data”) is input to the image processing portion 8.

The operation display portion 6 is a user interface of the image forming apparatus 100. The operation display portion 6 includes a display portion and an operation portion. The display portion displays various types of information in response to control instructions from the control portion 7. For example, the display portion is a flat panel display such as a liquid crystal display. The operation portion is used to input various types of information to the control portion 7 in accordance with user operations. For example, the operation portion includes an operation key and a touch panel.

The control portion 7 collectively controls the image forming apparatus 100. As shown in FIG. 3, the control portion 7 includes a CPU 61, a ROM 62, and a RAM 63. The CPU 61 is a processor that executes various types of arithmetic processing. The ROM 62 is a nonvolatile storage device in which information such as control programs for causing the CPU 61 to execute various types of processing is stored in advance. The RAM 63 is a volatile or nonvolatile storage device that is used as a temporary storage memory (working area) for the various type of processing to be executed by the CPU 61. The CPU 61 executes the various control programs stored in advance in the ROM 62, to thus collectively control the image forming apparatus 100.

The image processing portion 8 adjusts, based on image data input from the shape reading portion 5, image data to be input to the image forming portion 3, that is, image data to be used for forming an image on a sheet. For example, based on the image data input from the shape reading portion 5, the image processing portion 8 masks a portion to be used for the image formation on an outer side of the sheet conveyed along the sheet conveying path R11 out of the image data to be input to the image forming portion 3. Thus, discharge of ink to the outer side of the sheet is suppressed. The image processing portion 8 is constituted of an electronic circuit such as an integrated circuit (ASIC, DSP).

Incidentally, there is known, as the related art, an image forming apparatus capable of detecting, based on an image pickup result of the line sensor 51 on a mark image that is formed on the conveying belt 41 and is elongated in the width direction D12, a tilt of the line sensor 51 with respect to the width direction D12.

In the image forming apparatus according to the related art described above, however, when a shaft of the tension roller stretching the conveying belt 41 is tilted with respect to the width direction D12, the mark image tilts with respect to the width direction D12. Therefore, in the image forming apparatus according to the related art described above, when the shaft of the tension roller is tilted with respect to the width direction D12, the tilt of the line sensor 51 with respect to the width direction D12 is not reflected on the image pickup result obtained by the line sensor 51.

In contrast, the image forming apparatus 100 according to the embodiment of the present disclosure is capable of forming an image on which the tilt of the line sensor 51 is reflected as will be described below.

As shown in FIG. 3, the control portion 7 includes a conveyance processing portion 64 and a forming processing portion 65. Specifically, the CPU 61 of the control portion 7 executes the control programs stored in the ROM 62 to thus function as the conveyance processing portion 64 and the forming processing portion 65. It is noted that the conveyance processing portion 64 and the forming processing portion 65 may alternatively be realized by an electronic circuit.

Further, as shown in FIG. 3, the image processing portion 8 includes an acquisition processing portion 71 and a mask processing portion 72. It is noted that the CPU 61 of the control portion 7 may execute the control programs stored in the ROM 62 to thus function as the respective processing portions described above.

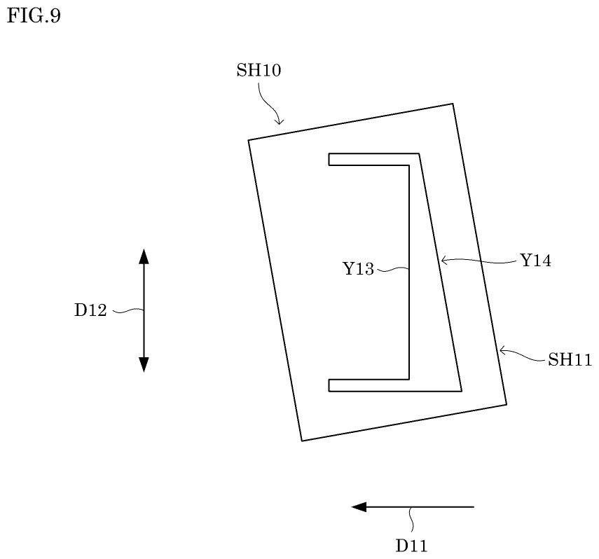

The conveyance processing portion 64 executes conveyance processing for conveying a predetermined specific sheet SH10 (see FIG. 9) along the sheet conveying path R11. Herein, the specific sheet SH10 is a sheet of a predetermined size. For example, the specific sheet SH10 is a sheet that is elongated in the width direction D12.

For example, the conveyance processing portion 64 causes the operation display portion 6 to display a guide screen in accordance with a predetermined user operation performed in the operation display portion 6. The guide screen includes a message that prompts the user to place the specific sheet SH10 on the sheet feed cassette 11. In addition, the guide screen includes an execution key used for performing an execution operation of the conveyance processing.

Then, when a user operation to the execution key is accepted, the conveyance processing portion 64 executes the conveyance processing. In the conveyance processing, the sheet conveying portion 2 and the conveying unit 4 are used to convey the specific sheet SH10 along the sheet conveying path R11.

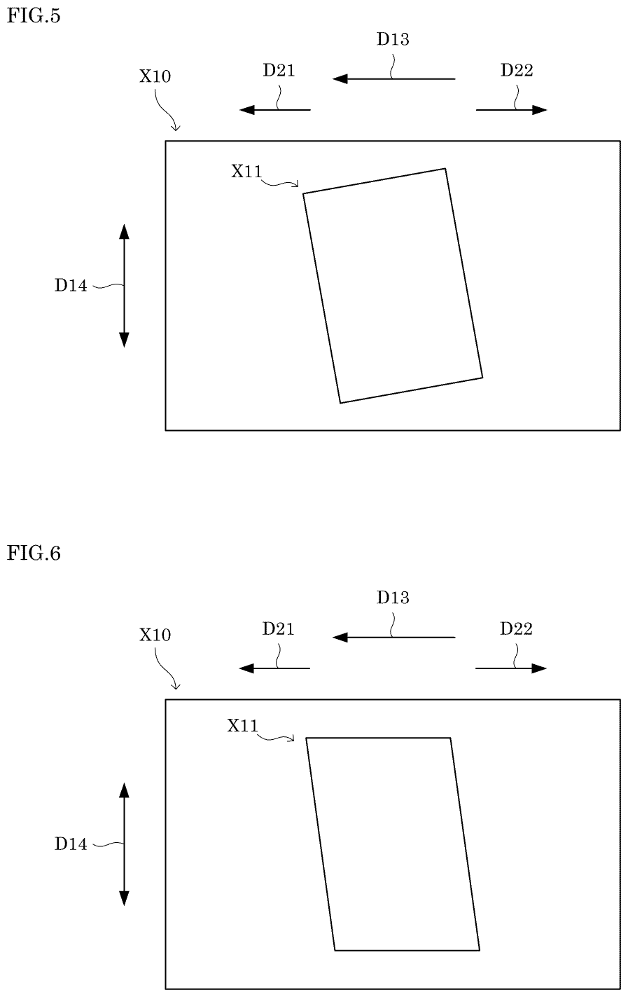

The acquisition processing portion 71 acquires, using the line sensor 51, shape data X10 (see FIG. 5) that indicates a shape of the specific sheet SH10 conveyed by the conveyance processing portion 64.

For example, when a tip end of the specific sheet SH10 is detected by a sheet sensor (not shown) provided more on the upstream side of the conveying direction D11 than the line sensor 51 on the sheet conveying path R11 (see FIG. 1), the acquisition processing portion 71 causes the shape reading portion 5 to start reading the shape of the specific sheet SH10. Thus, the line data is output from the shape reading portion 5 at the image pickup cycle. Further, when a predetermined specific time has elapsed since detection of a rear end of the specific sheet SH10 by the sheet sensor, the acquisition processing portion 71 causes the shape reading portion 5 to stop the reading of the shape of the specific sheet SH10. The specific time is set such that the reading of the shape of the specific sheet SH10 by the shape reading portion 5 ends after the rear end of the specific sheet SH10 passes through an opposing position that opposes the line sensor 51. Then, the acquisition processing portion 71 acquires each piece of the line data output from the shape reading portion 5 during a reading period of the shape of the specific sheet SH10 by the shape reading portion 5. In other words, the shape data X10 is data constituted of the plurality of pieces of line data that are output from the shape reading portion 5 during the reading period of the shape of the specific sheet SH10 by the shape reading portion 5.

FIG. 5 shows an example of the shape data X10. The shape data X10 shown in FIG. 5 is the shape data X10 acquired by the acquisition processing portion 71 in a case where the specific sheet SH10 is tilted with respect to the width direction D12 and the line sensor 51 is not tilted with respect to the width direction D12. The shape data X10 includes a sheet area X11 indicating the specific sheet SH10. The sheet area X11 is an area formed by pixels indicating presence of a sheet. An outer side of the sheet area X11 in the shape data X10 is formed by pixels indicating absence of a sheet.

Further, FIG. 6 shows another example of the shape data X10. The shape data X10 shown in FIG. 6 is the shape data X10 acquired by the acquisition processing portion 71 in a case where the specific sheet SH10 is not tilted with respect to the width direction D12 and the line sensor 51 is tilted with respect to the width direction D12 as shown in FIG. 2. It is noted that a first direction D13 shown in FIG. 5 and FIG. 6 is a direction corresponding to the conveying direction D11 (see FIG. 2). Moreover, a second direction D14 shown in FIG. 5 and FIG. 6 is a direction corresponding to the width direction D12 (see FIG. 2).

As shown in FIG. 5, when the specific sheet SH10 is tilted with respect to the width direction D12, a front end portion and rear end portion of the sheet area X11 in the first direction D13 become nonparallel to the second direction D14. Further, as shown in FIG. 6, when the line sensor 51 is tilted with respect to the width direction D12, the front end portion and rear end portion of the sheet area X11 in the first direction D13 become nonparallel to the second direction D14. In other words, both of the tilt amount of the specific sheet SH10 with respect to the width direction D12 and the tilt amount of the line sensor 51 with respect to the width direction D12 are reflected on the tilt amount of the front end portion and rear end portion of the sheet area X11 included in the shape data X10 in the first direction D13 with respect to the second direction D14.

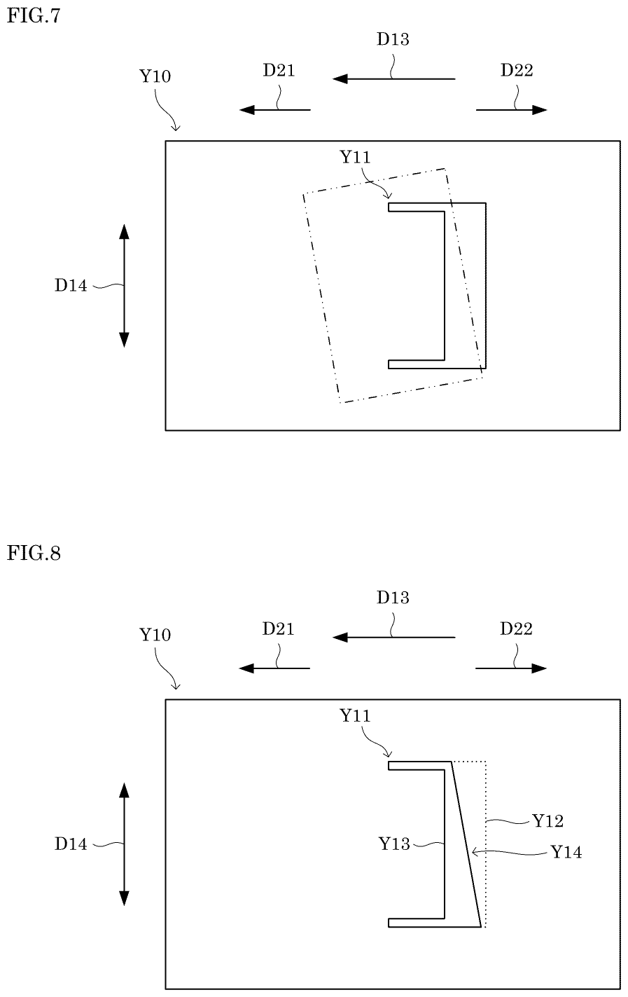

The mask processing portion 72 executes mask processing for masking, using the shape data X10 (see FIG. 5) acquired by the acquisition processing portion 71, a stick-out area that sticks out from the sheet area X11 out of specific image data Y10 (see FIG. 7) whose size in the first direction D13 corresponding to the conveying direction D11 is larger than that of the sheet area X11.

For example, the mask processing portion 72 determines, as the stick-out area, an outer side of an area of the specific image data Y10 that overlaps with the sheet area X11 in a case where the shape data X10 is superimposed on the specific image data Y10 such that a first reference position in the specific image data Y10 and a second reference position in the shape data X10 match.

For example, the first reference position is a position at a center of the specific image data Y10 in both the first direction D13 and the second direction D14. Further, the second reference position is a position at a center of the shape data X10 in both the first direction D13 and the second direction D14.

For example, the specific image data Y10 is data having the same size as the shape data X10. It is noted that the specific image data Y10 may alternatively be data having a different size from the shape data X10.

For example, in a case where pixels of the stick-out area in the specific image data Y10 are pixels of a color different from white, the mask processing portion 72 substitutes the pixels by white pixels to thus mask the stick-out area.

For example, the mask processing portion 72 executes the mask processing on a plurality of pixel rows that are included in the specific image data Y10 and are arranged along the second direction D14 sequentially along the first direction D13 from the pixel row arranged most downstream in the first direction D13. Specifically, every time the line data is acquired by the acquisition processing portion 71, the mask processing portion 72 determines the stick-out area included in the pixel row based on the acquired line data, and masks the determined stick-out area.

FIG. 7 shows an example of the specific image data Y10. It is noted that in FIG. 7, an area of the specific image data Y10 that overlaps with the sheet area X11 is indicated by a dash-dot-dot line. The specific image data Y10 includes a colored area Y11. The colored area Y11 is arranged at a position that overlaps with an end portion of the sheet area X11 on a side of a fourth direction D22 (an example of a second direction according to the present disclosure) provided along the first direction D13 in the specific image data Y10, based on a distance between the sheet sensor and the line sensor 51 on the sheet conveying path R11 (see FIG. 1) and a conveying speed of a sheet. The fourth direction D22 is a direction opposite to the first direction D13. The colored area Y11 is formed in a strip shape elongated in the second direction D14. Further, the colored area Y11 includes a pair of protrusion portions that protrude toward the downstream side of the first direction D13 from both end portions of a strop portion in the second direction D14. The colored area Y11 is an image having a size that fits inside the specific sheet SH10. The colored area Y11 is arranged at a center of the specific image data Y10 in the second direction D14. For example, the colored area Y11 is an area colored in black. An outer side of the colored area Y11 in the specific image data Y10 is a colorless area. In other words, the outer side of the colored area Y11 in the specific image data Y10 is formed by white pixels. It is noted that the colored area Y11 may alternatively be arranged at a position that overlaps with an end portion of the sheet area X11 on a side of a third direction D21 (another example of the second direction according to the present disclosure) opposite to the fourth direction D22 in the specific image data Y10. Alternatively, the colored area Y11 may be an area that occupies the entire specific image data Y10. Furthermore, the color of the colored area Y11 is not limited to black and only needs to be a color other than white.

Further, FIG. 8 shows an example of the specific image data Y10 in which the stick-out area has been masked by the mask processing portion 72. It is noted that in FIG. 8, a mask area Y12 masked by the mask processing portion 72 out of the colored area Y11 is indicated by a dotted line. Also in FIG. 8, a non-mask area Y13 not masked by the mask processing portion 72 out of the colored area Y11 is indicated by a solid line.

As shown in FIG. 7 and FIG. 8, by the masking of the stick-out area in the specific image data Y10 by the mask processing portion 72, the shape of the end portion of the sheet area X11 on the fourth direction D22 side (see FIG. 5 and FIG. 6) appears as a boundary between the mask area Y12 and the non-mask area Y13. In other words, an end portion Y14 of the non-mask area Y13 on the fourth direction D22 side (see FIG. 8) has the same shape as the end portion of the sheet area X11 on the fourth direction D22 side. Accordingly, both of the tilt amount of the specific sheet SH10 with respect to the width direction D12 and the tilt amount of the line sensor 51 with respect to the width direction D12 are reflected on a tilt amount of the end portion Y14 with respect to the second direction D14.

The forming processing portion 65 forms, on the specific sheet SH10, an image that shows the boundary between the mask area and the non-mask area that oppose each other along the first direction D13 out of the specific image data Y10 (see FIG. 8) in which the stick-out area has been masked by the mask processing portion 72.

For example, of the colored area Y11 included in the specific image data Y10, the forming processing portion 65 forms the non-mask area Y13 (see FIG. 8) on the specific sheet SH10.

For example, the forming processing portion 65 inputs, to the image forming portion 3, the plurality of pixel rows that are included in the specific image data Y10 in which the stick-out area has been masked and are arranged along the second direction D14 sequentially along the first direction D13 from the pixel row arranged most downstream in the first direction D13. Further, the forming processing portion 65 starts the input of each of the pixel rows to the image forming portion 3 at a predetermined input timing. The input timing is set so that the entire non-mask area Y13 is formed on the specific sheet SH10. Thus, in the image forming portion 3, every time the pixel row is input, the discharge of ink by the line head 31 is controlled based on the input pixel row, and the non-mask area Y13 is formed on the specific sheet SH10.

FIG. 9 shows an example of the non-mask area Y13 formed on the specific sheet SH10 by the forming processing portion 65. Specifically, FIG. 9 shows the non-mask area Y13 formed on the specific sheet SH10 by the forming processing portion 65 in a case where the specific sheet SH10 is tilted with respect to the width direction D12 and the line sensor 51 is not tilted with respect to the width direction D12.

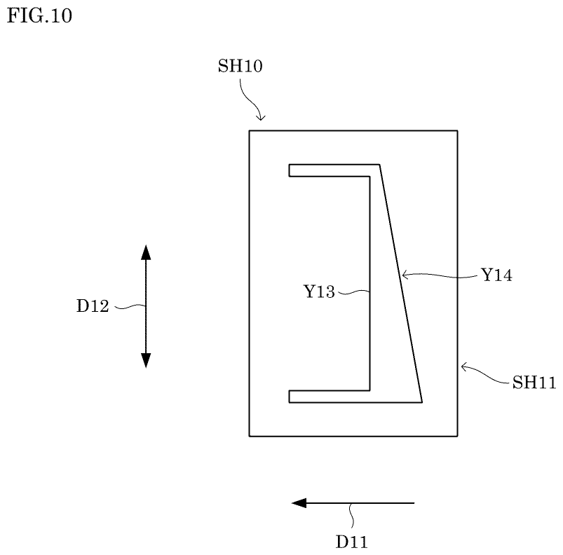

Further, FIG. 10 shows another example of the non-mask area Y13 formed on the specific sheet SH10 by the forming processing portion 65. Specifically, FIG. 10 shows the non-mask area Y13 formed on the specific sheet SH10 by the forming processing portion 65 in a case where the specific sheet SH10 is not tilted with respect to the width direction D12 and the line sensor 51 is tilted with respect to the width direction D12.

As described above, both of the tilt amount of the specific sheet SH10 with respect to the width direction D12 and the tilt amount of the line sensor 51 with respect to the width direction D12 are reflected on the tilt amount of the end portion Y14 with respect to the second direction D14 in the non-mask area Y13. Meanwhile, a tilt amount of an end portion SH11 (see FIG. 9 and FIG. 10) of the specific sheet SH10 formed with the non-mask area Y13 on the upstream side of the conveying direction D11 with respect to the width direction D12 is the same as the tilt amount of the specific sheet SH10 with respect to the width direction D12. In other words, only the tilt amount of the line sensor 51 with respect to the width direction D12 is reflected on the tilt amount of the end portion Y14 with respect to the end portion SH11. Accordingly, a worker who performs an adjustment work of an attitude of the line sensor 51 can measure the tilt amount of the end portion Y14 with respect to the end portion SH11 in the specific sheet SH10 formed with the non-mask area Y13, to thus recognize the tilt amount of the line sensor 51 with respect to the width direction D12.

### [Tilt-Reflected Image Forming Processing]

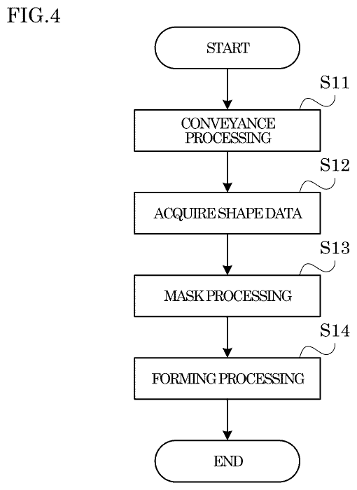

Hereinafter, with reference to FIG. 4, an image forming method according to the present disclosure will be described along with exemplary procedures of tilt-reflected image forming processing executed by the control portion 7 and the image processing portion 8 in the image forming apparatus 100. Herein, Step S11, Step S12, . . . represent numbers of processing procedures (steps) executed by the control portion 7 or the image processing portion 8. It is noted that the tilt-reflected image forming processing is executed when a user operation to the execution key is accepted in the guide screen.

### <Step S11>

First, in Step S11, the control portion 7 executes the conveyance processing for conveying the specific sheet SH10 along the sheet conveying path R11. The processing of Step S11 is an example of a conveying step according to the present disclosure and is executed by the conveyance processing portion 64 of the control portion 7.

### <Step S12>

In Step S12, the image processing portion 8 acquires the shape data X10 (see FIG. 5) indicating the shape of the specific sheet SH10 conveyed by the conveyance processing using the line sensor 51. The processing of Step S12 is an example of an acquisition step according to the present disclosure and is executed by the acquisition processing portion 71 of the image processing portion 8.

Specifically, when a tip end of the specific sheet SH10 is detected by the sheet sensor, the image processing portion 8 causes the shape reading portion 5 to start reading the shape of the specific sheet SH10. Further, when the specific time has elapsed since the detection of the rear end of the specific sheet SH10 by the sheet sensor, the image processing portion 8 causes the shape reading portion 5 to stop the reading of the shape of the specific sheet SH10. Then, the image processing portion 8 acquires each piece of the line data output from the shape reading portion 5 during the reading period of the shape of the specific sheet SH10 by the shape reading portion 5.

### <Step S13>

In Step S13, the image processing portion 8 executes the mask processing for masking, using the shape data X10 acquired by the processing of Step S12, the stick-out area that sticks out from the sheet area X11 out of the specific image data Y10 (see FIG. 7). The processing of Step S13 is an example of a mask step according to the present disclosure and is executed by the mask processing portion 72 of the image processing portion 8.

Specifically, the image processing portion 8 executes the mask processing on the plurality of pixel rows that are included in the specific image data Y10 and are arranged along the second direction D14 sequentially along the first direction D13 from the pixel row arranged most downstream in the first direction D13. More specifically, every time the line data is acquired by the processing of Step S12, the image processing portion 8 determines the stick-out area included in the pixel row based on the acquired line data, and masks the determined stick-out area.

### <Step S14>

In Step S14, the control portion 7 forms, on the specific sheet SH10, the non-mask area Y13 (see FIG. 8) included in the specific image data Y10 in which the stick-out area has been masked by the processing of Step S13. The processing of Step S14 is an example of a forming step according to the present disclosure and is executed by the forming processing portion 65 of the control portion 7.

Specifically, the control portion 7 inputs, to the image forming portion 3, the plurality of pixel rows that are included in the specific image data Y10 in which the stick-out area has been masked and are arranged along the second direction D14 sequentially along the first direction D13 from the pixel row arranged most downstream in the first direction D13. Further, the control portion 7 starts the input of each of the pixel rows to the image forming portion 3 at the input timing. Thus, in the image forming portion 3, every time the pixel row is input, the discharge of ink by the line head 31 is controlled based on the input pixel row, and the non-mask area Y13 is formed on the specific sheet SH10.

In this manner, in the image forming apparatus 100, the shape data X10 indicating the shape of the specific sheet SH10 conveyed along the sheet conveying path R11 is acquired. Further, the acquired shape data X10 is used to mask the stick-out area that sticks out from the sheet area X11 out of the specific image data Y10. Furthermore, the non-mask area Y13 included in the specific image data Y10 in which the stick-out area has been masked is formed on the specific sheet SH10. Thus, it is possible to form an image on which the tilt of the line sensor 51 is reflected.

Further, in the image forming apparatus 100, the colored area Y11 (see FIG. 7) is arranged at a position that overlaps with the end portion of the sheet area X11 on the fourth direction D22 side (the rear end portion) in the specific image data Y10. Thus, compared to a configuration in which the colored area Y11 is arranged at a position that overlaps with the end portion of the sheet area X11 on the third direction D21 side (the tip end portion) in the specific image data Y10, since the non-mask area Y13 (see FIG. 8) is formed based on an image pickup result of the specific sheet SH10 not nipped by the conveying rollers 22A (see FIG. 1), it is possible to form an image on which the tilt of the line sensor 51 is reflected with higher accuracy. It is noted that the conveying rollers 22A are the conveying rollers 22 that are closest to the line sensor 51 out of the conveying rollers 22 arranged more on the upstream side of the conveying direction D11 than the line sensor 51 on the sheet conveying path R11.

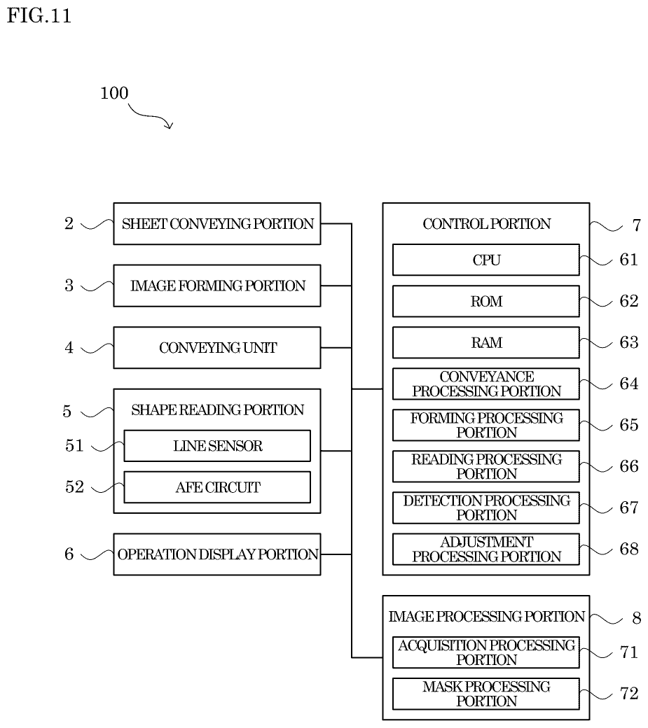

It is noted that the control portion 7 may include a reading processing portion 66, a detection processing portion 67, and an adjustment processing portion 68 shown in FIG. 11.

The reading processing portion 66 reads an image formed on the specific sheet SH10 by the forming processing portion 65. For example, the reading processing portion 66 uses a scanner connected to the image forming apparatus 100 to read the non-mask area Y13 formed on the specific sheet SH10.

The detection processing portion 67 detects the tilt amount of the line sensor 51 with respect to the width direction D12 based on the image read by the reading processing portion 66. For example, the detection processing portion 67 calculates a tilt angle of the end portion Y14 of the non-mask area Y13 (see FIG. 10) with respect to the end portion SH11 of the specific sheet SH10 (see FIG. 10), and acquires the calculated tilt angle as the tilt amount of the line sensor 51 with respect to the width direction D12.

The adjustment processing portion 68 adjusts the attitude of the line sensor 51 based on the tilt amount detected by the detection processing portion 67. Specifically, the adjustment processing portion 68 adjusts the attitude of the line sensor 51 using an adjustment mechanism (not shown) capable of adjusting the attitude of the line sensor 51.

Thus, the attitude of the line sensor 51 can be adjusted automatically.

### [Notes of Disclosure]

Hereinafter, a general outline of the disclosure extracted from the embodiments described above will be noted. It is noted that the respective configurations and processing functions described in the notes below can be sorted and arbitrarily combined as appropriate.

### <Note 1>

An image forming apparatus, including: an image forming portion which forms an image on a sheet conveyed along a predetermined conveying path; an image pickup portion which is provided while being elongated along a width direction orthogonal to a conveying direction of the sheet at a position more on an upstream side of the conveying direction than the image forming portion on the conveying path, and images the sheet; a conveyance processing portion which conveys a predetermined specific sheet along the conveying path; an acquisition processing portion which acquires shape data indicating a shape of the specific sheet conveyed by the conveyance processing portion using the image pickup portion; a mask processing portion which masks, using the shape data acquired by the acquisition processing portion, a stick-out area that sticks out from a sheet area included in the shape data out of specific image data whose size in a first direction corresponding to the conveying direction is larger than that of the sheet area; and a forming processing portion which forms, on the specific sheet, an image that shows a boundary between a mask area and a non-mask area opposing each other along the first direction out of the specific image data in which the stick-out area has been masked by the mask processing portion.

### <Note 2>

The image forming apparatus according to note 1, in which the mask processing portion determines, as the stick-out area, an outer side of an area of the specific image data that overlaps with the sheet area in a case where the shape data is superimposed on the specific image data such that a first reference position in the specific image data and a second reference position in the shape data match, and the specific image data includes a colored area arranged at a position that overlaps with an end portion of the sheet area on a side of a second direction provided along the first direction.

### <Note 3>

The image forming apparatus according to note 2, in which the second direction is a direction opposite to the first direction.

### <Note 4>

The image forming apparatus according to any one of notes 1 to 3, including: a reading processing portion which reads the image formed on the specific sheet by the forming processing portion; and a detection processing portion which detects a tilt amount of the image pickup portion with respect to the width direction based on the image read by the reading processing portion.

### <Note 5>

The image forming apparatus according to note 4, including: an adjustment processing portion which adjusts an attitude of the image pickup portion based on the tilt amount detected by the detection processing portion.

### <Note 6>

An image forming method executed in an image forming apparatus including an image forming portion which forms an image on a sheet conveyed along a predetermined conveying path, and an image pickup portion which is provided while being elongated along a width direction orthogonal to a conveying direction of the sheet at a position more on an upstream side of the conveying direction than the image forming portion on the conveying path, and images the sheet, the image forming method including: a conveyance step of conveying a predetermined specific sheet along the conveying path; an acquisition step of acquiring shape data indicating a shape of the specific sheet conveyed in the conveyance step using the image pickup portion; a mask step of masking, using the shape data acquired in the acquisition step, a stick-out area that sticks out from a sheet area included in the shape data out of specific image data whose size in a first direction corresponding to the conveying direction is larger than that of the sheet area; and a forming step of forming, on the specific sheet, an image that shows a boundary between a mask area and a non-mask area opposing each other along the first direction out of the specific image data in which the stick-out area has been masked in the mask step.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus, comprising:
an image forming portion which forms an image on a sheet conveyed along a predetermined conveying path;
an image pickup portion which is provided while being elongated along a width direction orthogonal to a conveying direction of the sheet at a position more on an upstream side of the conveying direction than the image forming portion on the conveying path, and images the sheet;
a conveyance processing portion which conveys a predetermined specific sheet along the conveying path;
an acquisition processing portion which acquires shape data indicating a shape of the specific sheet conveyed by the conveyance processing portion using the image pickup portion;
a mask processing portion which masks, using the shape data acquired by the acquisition processing portion, a stick-out area that sticks out from a sheet area included in the shape data out of specific image data whose size in a first direction corresponding to the conveying direction is larger than that of the sheet area; and
a forming processing portion which forms, on the specific sheet, an image that shows a boundary between a mask area and a non-mask area opposing each other along the first direction out of the specific image data in which the stick-out area has been masked by the mask processing portion.

2. The image forming apparatus according to claim 1, wherein
the mask processing portion determines, as the stick-out area, an outer side of an area of the specific image data that overlaps with the sheet area in a case where the shape data is superimposed on the specific image data such that a first reference position in the specific image data and a second reference position in the shape data match, and
the specific image data includes a colored area arranged at a position that overlaps with an end portion of the sheet area on a side of a second direction provided along the first direction.

3. The image forming apparatus according to claim 2, wherein
the second direction is a direction opposite to the first direction.

4. The image forming apparatus according to claim 1, comprising:
a reading processing portion which reads the image formed on the specific sheet by the forming processing portion; and
a detection processing portion which detects a tilt amount of the image pickup portion with respect to the width direction based on the image read by the reading processing portion.

5. The image forming apparatus according to claim 4, comprising:
an adjustment processing portion which adjusts an attitude of the image pickup portion based on the tilt amount detected by the detection processing portion.

6. An image forming method executed in an image forming apparatus including an image forming portion which forms an image on a sheet conveyed along a predetermined conveying path, and an image pickup portion which is provided while being elongated along a width direction orthogonal to a conveying direction of the sheet at a position more on an upstream side of the conveying direction than the image forming portion on the conveying path, and images the sheet, the image forming method comprising:
a conveyance step of conveying a predetermined specific sheet along the conveying path;
an acquisition step of acquiring shape data indicating a shape of the specific sheet conveyed in the conveyance step using the image pickup portion;
a mask step of masking, using the shape data acquired in the acquisition step, a stick-out area that sticks out from a sheet area included in the shape data out of specific image data whose size in a first direction corresponding to the conveying direction is larger than that of the sheet area; and
a forming step of forming, on the specific sheet, an image that shows a boundary between a mask area and a non-mask area opposing each other along the first direction out of the specific image data in which the stick-out area has been masked in the mask step.
